(19) United States
(12) Patent Application Publication
(10) Pub. No.: US 2025/0175983 A1
(43) Pub. Date: May 29, 2025

(54) TERMINAL AND RADIO COMMUNICATION METHOD

(71) Applicant: NTT DOCOMO, INC., Tokyo (JP)

(72) Inventors: Shohei Yoshioka, Tokyo (JP); Hiroki Harada, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 18/839,978

(22) PCT Filed: Feb. 16, 2023
(86) PCT No.: PCT/JP2023/005396

§ 371 Date: Aug. 20, 2024

(30) Foreign Application Priority Data
Feb. 21, 2022 (JP) 2022-025027

(51) Int. Cl. H04W 72/1273; H04W 72/232; H04W 76/10

(52) U.S. Cl. CPC H04W 72/1273; H04W 72/232; H04W 76/10

(57) ABSTRACT

A terminal includes: a reception unit that receives data via a downlink channel scheduled using common downlink control information common to a plurality of terminals in a data delivery to the plurality of terminals; and a control unit that performs a specific operation as an operation for receiving at least one logical channel from among a logical control channel and a logical traffic channel related to the data delivery to the plurality of terminals, depending on whether to support a specific function for receiving the at least one logical channel.

### TECHNICAL FIELD

The present disclosure relates to a terminal and radio communication method supporting a multicast/broadcast service.

### BACKGROUND ART

The 3rd Generation Partnership Project (3GPP) has prepared a specification for the 5th generation mobile communication system (also referred to as 5G, New Radio (NR), or Next Generation (NG)), and further a specification for a next-generation system referred to as Beyond 5G, 5G Evolution, or 6G is also being prepared.

In 3GPP Release 17, simultaneous data transmission (also referred to as delivery) services to a plurality of specific or unspecified terminals (User Equipment, UE) in NR (referred to as Multicast and Broadcast Services (MBS) (provisional name)) are investigation targets (Non-Patent Literature 1).

In MBS, a method for scheduling a group-common PDSCH (hereinafter referred to as PTM-1) is supported, which uses a group-common Physical Downlink Control Channel (PDCCH) common to a plurality of groups of UEs receiving data on the MBS, for example.

### CITATION LIST

### Non-Patent Literature

Non-Patent Literature 1: “New Work Item on NR support of Multicast and Broadcast Services”, RP-193248, 3GPP TSG RAN Meeting #86, 3GPP, December 2019

### SUMMARY OF THE INVENTION

Incidentally, in the PTM-1, a UE reports to the network whether to support a function (UE Capability) for receiving a logical control channel (hereinafter referred to as Multicast Control Channel (MCCH)), and a logical traffic channel (hereinafter referred to as Multicast Traffic Channel (MTCH)) for the MBS.

Under this kind of background, as a result of intensive investigation, the inventors have found the necessity to clarify an operation of a UE that does not support a function for receiving the MCCH/MTCH, by assuming a case where a UE that supports a function for receiving the MCCH/MTCH and the UE that does not support the function for receiving the MCCH/MTCH are mixed.

Therefore, the present disclosure has been made in view of this kind of situation, and an object of the present disclosure is to provide a terminal and a radio communication method in which a UE that does not support a function for receiving the MCCH/MTCH can operate appropriately.

An aspect of the disclosure provides a terminal including: a reception unit that receives data via a downlink channel scheduled using common downlink control information common to a plurality of terminals in a data delivery to the plurality of terminals; and a control unit that performs a specific operation as an operation for receiving at least one logical channel from among a logical control channel and a logical traffic channel related to the data delivery to the plurality of terminals, depending on whether to support a specific function for receiving the at least one logical channel.

An aspect of the disclosure provides a radio communication method including: a step of receiving data via a downlink channel scheduled using common downlink control information common to a plurality of terminals in a data delivery to the plurality of terminals; and a step of performing a specific operation as an operation for receiving at least one logical channel from among a logical control channel and a logical traffic channel related to the data delivery to the plurality of terminals, depending on whether to support a specific function for receiving the at least one logical channel.

### BRIEF DESCRIPTION OF THE DRAWINGS

FIG. 1 is an overall schematic configuration diagram of a radio communication system 10.

FIG. 2 is a diagram showing a frequency range used in the radio communication system 10.

FIG. 3 is a diagram showing configuration examples of radio frames, subframes, and slots used in the radio communication system 10.

FIG. 4 is a functional block diagram of a UE 200.

FIG. 5 is a functional block diagram of a gNB 100.

FIG. 6 is a diagram showing configuration examples of a PTM transmission method 1 and a PTM transmission method 2.

FIG. 7 is a diagram for explaining operation examples.

FIG. 8 is a diagram showing an example of a hardware configuration of the gNB 100 and UE 200.

FIG. 9 is a diagram showing a configuration example of a vehicle 2001.

### DESCRIPTION OF EMBODIMENTS

Embodiments will be explained below with reference to the accompanying drawings. Note that the same or similar reference numerals have been attached to the same functions and configurations, and the description thereof will be omitted as appropriate.

### Embodiments

### (1) Overall Schematic Configuration of Radio Communication System

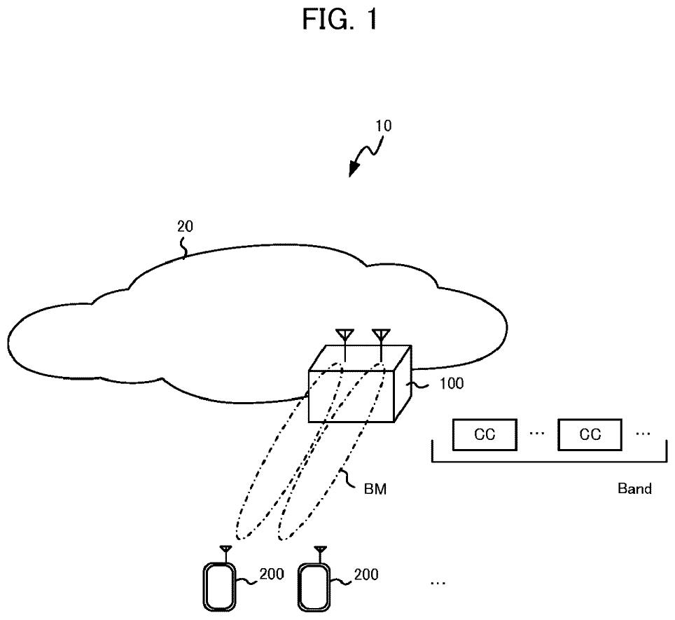

FIG. 1 is an overall schematic configuration diagram of a radio communication system 10 according to an embodiment. The radio communication system 10 is compliant with 5G New Radio (NR) and includes a Next Generation-Radio Access Network 20 (hereinafter referred to as NG-RAN 20) and a terminal 200 (hereinafter referred to as User Equipment (UE) 200).

The radio communication system 10 may be compliant with a method referred to as Beyond 5G, 5G Evolution, or 6G.

The NG-RAN 20 includes a base station 100 (hereinafter referred to as gNB 100). A specific configuration of the radio communication system 10 including the number of gNBs 100 and UEs 200 is not limited to the example shown in FIG. 1.

The NG-RAN 20 actually includes a plurality of NG-RAN Nodes, specifically, gNBs (or ng-eNBs), and is connected to a 5G-compliant core network (hereinafter referred to as 5GC, not shown). The NG-RAN 20 and 5GC may simply be expressed as a “network”.

The gNB 100 is a radio base station that is compliant with 5G and performs radio communication according to 5G with the UE 200. The gNB 100 and UE 200 can support Massive Multiple-Input Multiple-Output (MIMO) generating a beam BM with higher directivity by controlling radio signals transmitted from a plurality of antenna elements; Carrier Aggregation (CA) bundling and using a plurality of Component Carriers (CCs), and Dual Connectivity (DC) simultaneously communicating to two or more transport blocks between the UE and each of the two NG-RAN Nodes.

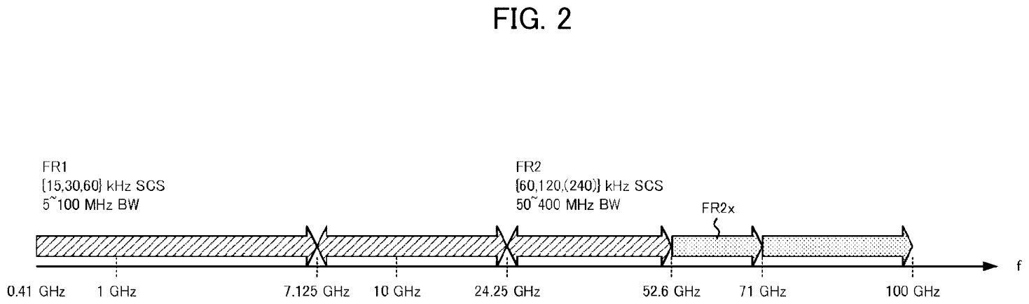

Further, the radio communication system 10 supports a plurality of frequency ranges (FRs). FIG. 2 shows frequency ranges used in the radio communication system 10.

As shown in FIG. 2, the radio communication system 10 supports an FR 1 and an FR 2. Frequency bands of each FR are as follows.
FR 1: 410 MHz to 7.125 GHz
FR 2: 24.25 GHz to 52.6 GHz

In the FR 1, Sub-Carrier Spacing (SCS) of 15, 30, or 60 kHz is used, and a bandwidth (BW) of 5 to 100 MHz may be used. The FR 2 is higher frequency than the FR 1, an SCS of 60 or 120 kHz (240 kHz may be included) is used, and a bandwidth (BW) of 50 to 400 MHz may be used.

The SCS may be interpreted as numerology. The numerology is defined in 3GPP TS38.300 and corresponds to one subcarrier interval in a frequency domain.

In addition, the radio communication system 10 supports a higher frequency band than the frequency band of the FR 2. Specifically, the radio communication system 10 supports a frequency band of more than 52.6 GHz and 71 GHz or less or 114.25 GHz or less. This kind of high frequency band may be referred to as “FR 2x”, for convenience.

In order to solve a problem that an influence of phase noise increases in a high frequency band, when a band of more than 52.6 GHz is used, Cyclic Prefix-Orthogonal Frequency Division Multiplexing (CP-OFDM)/Discrete Fourier Transform-Spread (DFT-S-OFDM) with larger Sub-Carrier Spacing (SCS) may be applied.

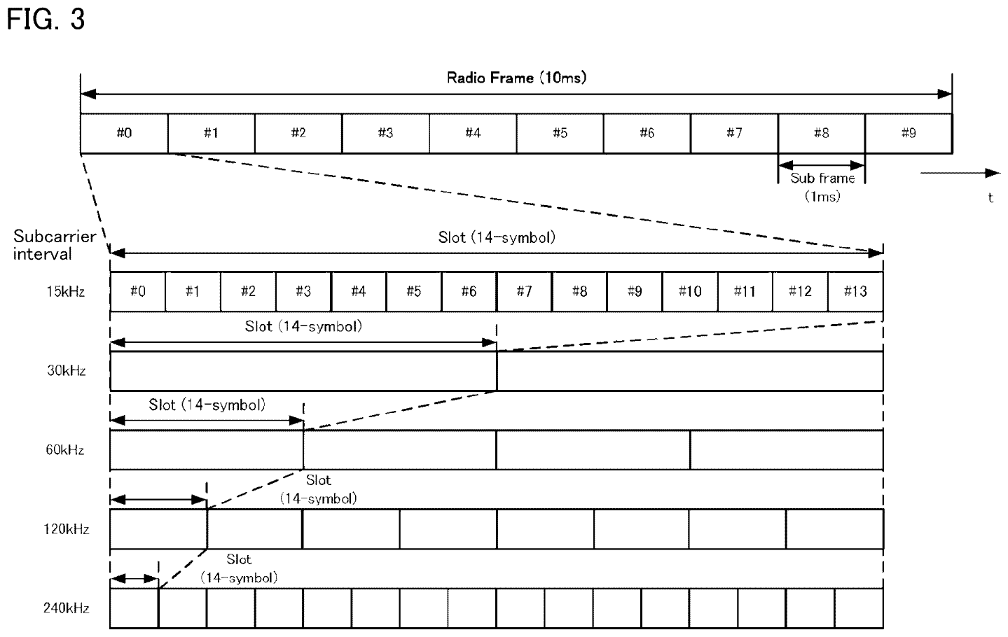

FIG. 3 shows a configuration example of radio frames, subframes, and slots used in the radio communication system 10.

As shown in FIG. 3, 14 symbols constitute one slot, and the larger (wider) the SCS, the shorter the symbol period (and the slot period). The SCS is not limited to an interval (frequency) shown in FIG. 3. For example, 480 kHz, 960 kHz, and the like may be used.

Further, the number of symbols constituting one slot does not necessarily have to be 14 (for example, 28, 56 symbols). In addition, the number of slots per subframe may vary depending on the SCS.

Note that a time direction (t) shown in FIG. 3 may be referred to as a time domain, symbol period, or symbol time. Further, a frequency direction may be referred to as a frequency domain, resource block, subcarrier, Bandwidth part (BWP), or the like.

A DMRS is a type of reference signal and is prepared for various channels. In this case, unless otherwise specified, the DMRS may mean a DMRS for a downlink data channel, specifically, a DMRS for a Physical Downlink Shared Channel (PDSCH). However, a DMRS for an uplink data channel, specifically a DMRS for a Physical Uplink Shared Channel (PUSCH) may be interpreted in the same way as the DMRS for a PDSCH.

The DMRS may be used for channel estimation in the UE 200 as part of a device, for example, coherent demodulation. The DMRS may be present only in a resource block (RB) used for PDSCH transmission.

The DMRS may have a plurality of mapping types. Specifically, the DMRS has mapping type A and mapping type B. In the mapping type A, the first DMRS is allocated to a second or third symbol in a slot. In the mapping type A, the DMRS may be mapped based on a slot boundary regardless of where in the slot actual data transmission is initiated. The reason why the first DMRS is allocated to the second or third symbol in the slot may be interpreted as allocating the first DMRS after control resource sets (CORESET).

In the mapping type B, the first DMRS may be placed on a first symbol of data allocation. That is, a location of the DMRS may be given relative to where data is located, rather than relative to a slot boundary.

Further, the DMRS may have a plurality of Types. Specifically, the DMRS has Type 1 and Type 2. Type 1 and Type 2 differ in mapping and the maximum number of orthogonal reference signals in a frequency domain. In Type 1, it is possible to output a maximum of four orthogonal signals with a single-symbol DMRS, and in Type 2, it is possible to output a maximum of eight orthogonal signals with a double-symbol DMRS.

### (2) Functional Block Configuration of Radio Communication System

Next, a functional block configuration of the radio communication system 10 will be described.

First, a functional block configuration of the UE 200 will be described.

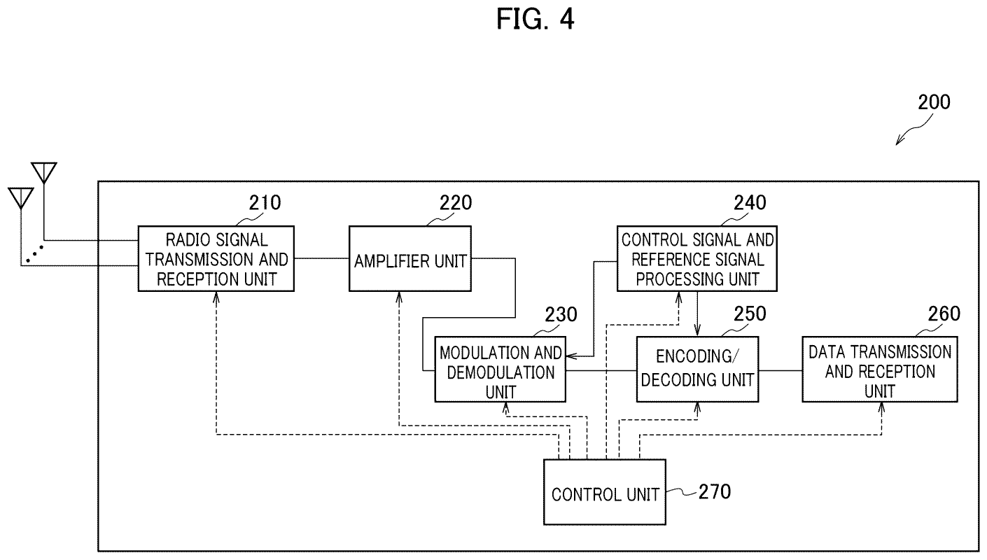

FIG. 4 is a functional block diagram of the UE 200. As shown in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives NR-compliant radio signals. The radio signal transmission and reception unit 210 supports Massive MIMO, CA bundling and using a plurality of CCs, and DC communicating simultaneously between the UE and each of the two NG-RAN Nodes.

The amplifier unit 220 is constituted by a Power Amplifier (PA)/a Low Noise Amplifier (LNA), or the like. The amplifier unit 220 amplifies a signal output from the modulation and demodulation unit 230 to have a predetermined power level. Further, the amplifier unit 220 amplifies an RF signal output from the radio signal transmission and reception unit 210.

The modulation and demodulation unit 230 performs data modulation/demodulation, transmission power configuration, resource block allocation, and the like for each predetermined communication destination (gNB 100 or another gNB). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for an uplink (UL) but also for a downlink (DL).

The control signal and reference signal processing unit 240 performs processing for various control signals transmitted and received by the UE 200, and processing for various reference signals transmitted and received by the UE 200.

Specifically, the control signal and reference signal processing unit 240 receives various control signals transmitted from the gNB 100 via a predetermined control channel, for example, control signals of a radio resource control layer (RRC). Further, the control signal and reference signal processing unit 240 transmits various control signals to the gNB 100 via the predetermined control channel.

The control signal and reference signal processing unit 240 performs processing using Reference Signals (RSs) such as a Demodulation Reference Signal (DMRS), a Phase Tracking Reference Signal (PTRS), and the like.

The DMRS is a terminal-specific reference signal (pilot signal) known between a base station and a terminal for estimating a fading channel used for data demodulation. The PTRS is a terminal-specific reference signal for the purpose of estimating phase noise, which becomes a problem in a high frequency band.

In addition to a DMRS and PTRS, the reference signal may include a Channel State Information-Reference Signal (CSI-RS), a Sounding Reference Signal (SRS), and a Positioning Reference Signal (PRS) for position information.

Further, the channel includes a control channel and a data channel. The control channel includes a Physical Downlink Control Channel (PDCCH), a Physical Uplink Control Channel (PUCCH), a Random Access Channel (RACH), Downlink Control Information (DCI) including a Random Access Radio Network Temporary Identifier (RA-RNTI), and a Physical Broadcast Channel (PBCH).

Further, the data channel includes a Physical Downlink Shared Channel (PDSCH), a Physical Uplink Shared Channel (PUSCH), and the like. The data means data transmitted via a data channel. The data channel may be read as a shared channel.

The control signal and reference signal processing unit 240 may receive downlink control information (DCI). The DCI includes, as existing fields, fields for storing DCI formats, a Carrier indicator (CI), BWP indicator, Frequency Domain Resource Assignment (FDRA), Time Domain Resource Assignment (TDRA), Modulation and Coding Scheme (MCS), HARQ Process Number (HPN), New Data Indicator (NDI), Redundancy Version (RV), and the like.

A value stored in a DCI format field is an information element for specifying a format of the DCI. A value stored in a CI field is an information element for specifying a CC to which the DCI is applied. A value stored in a BWP indicator field is an information element for specifying a BWP to which the DCI is applied. The BWP that can be specified using the BWP indicator is configured by an information element included in an RRC message (BandwidthPart-Config). A value stored in the FDRA field is an information element for specifying a frequency domain resource to which the DCI is applied. The frequency domain resource is identified by using the value stored in the FDRA field and the information element included in the RRC message (RA Type). A value stored in a TDRA field is an information element for specifying a time domain resource to which the DCI is applied. The time domain resource is identified by using the value stored in the TDRA field and the information element included in the RRC message (PDSCH-TimeDomainAllocationList, pusch-TimeDomainAllocationList). The time domain resource may be identified by using the value stored in the TDRA field and a default table. A value stored in the MCS field is an information element for specifying an MCS to which the DCI is applied. The MCS is identified by using the value stored in the MCS and an MCS table. The MCS table may be specified by using the RRC message or identified by using RNTI scrambling. A value stored in an HPN field is an information element for specifying an HARQ Process to which the DCI is applied. A value stored in the NDI is an information element for identifying whether the data to which the DCI is applied is initial transmission data. A value stored in an RV field is an information element for specifying redundancy of data to which the DCI is applied.

The encoding/decoding unit 250 performs data division/connection, channel coding/decoding, and the like for each predetermined communication destination (gNB 100 or another gNB).

Specifically, the encoding/decoding unit 250 divides data output from the data transmission and reception unit 260 into predetermined sizes, and performs channel coding on the divided data. Further, the encoding/decoding unit 250 decodes data output from the modulation and demodulation unit 230 and connects the decoded data.

The data transmission and reception unit 260 transmits and receives a Protocol Data Unit (PDU) and a Service Data Unit (SDU). Specifically, the data transmission and reception unit 260 performs assembly/disassembly and the like of PDUs/SDUs in a plurality of layers (medium access control layer (MAC), radio link control layer (RLC), and packet data convergence protocol layer (PDCP), and the like). Further, the data transmission and reception unit 260 performs data error correction and re-transmission control based on a Hybrid Automatic Repeat Request (HARQ).

In the embodiment, the data transmission and reception unit 260 constitutes a reception unit that receives data via a downlink channel in data delivery for a plurality of terminals (UEs 200). The data delivery for a plurality of terminals may be referred to as Multicast and Broadcast Services (MBS). The downlink channel may include a PDSCH (multicast) transmitted by multicast and a PDSCH (unicast) transmitted by unicast. In the following, the PDSCH (multicast) and PDSCH (unicast) are collectively referred to as a PDSCH (multicast/unicast). The reception of the PDSCH (multicast/unicast) may be read as the reception of data via the PDSCH (multicast/unicast). Specifically, the data transmission and reception unit 260 receives data via a downlink channel (hereinafter referred to as PDSCH) scheduled using common downlink control information (hereinafter referred to as common DCI) common to the plurality of UEs 200 in the MBS. The common DCI may be referred to as DCI for the MBS.

The control unit 270 controls each functional block constituting the UE 200. In the embodiment, the control unit 270 constitutes a control unit that performs a specific operation as an operation of receiving at least one of a logical control channel (hereinafter referred to as Multicast Control Channel, MCCH) and a logical traffic channel (hereinafter referred to as Multicast Traffic Channel, MTCH) related to the MBS, depending on whether or not a specific function for receiving the logical channel supported.

Although there are no particular limitations, the specific function may be at least any one of the following functions.

First, the specific function may be a function for supporting a dynamic repetition indication. The dynamic repetition indication may be explicitly or implicitly indicated by PDSCH-TimeDomainResourceAllocationList or explicitly or implicitly indicated by repetitionNumber-MTCH.

Second, the specific function may be a function for supporting RB-level rate-matching. In RB-level rate-matching, data is received and decoded assuming that there is no assignment to a specific RB. The RB-level rate-matching may be explicitly or implicitly indicated by rateMatchPatternToAddModList.

Third, the specific function may be a function for supporting RE-level rate-matching. In the RB-level rate-matching, data is received and decoded assuming that there is no assignment to a specific RE. The RE-level rate-matching may be explicitly or implicitly indicated by RateMatchPatternLTE-CRS for rate-matching for a LTE-CRS. The RE-level rate-matching may be explicitly or implicitly indicated by at least any one of zp-CSI-RS-ResourceToAddModList, aperiodic-ZP-CSI-RS-ResourceSetsToAddModList, sp-ZP-CSI-RS-ResourceSetsToAddModList, and zp-ZP-CSI-RS-ResourceSet for rate-matching for a Zero Power (ZP)-CSI-RS.

The common DCI is delivered by a Group-common PDCCH in PTM-1, which will be described later. The Group-common PDCCH is a PDCCH common to two or more UEs 200 receiving data in the MBS, and a CRC of the Group-common PDCCH is scrambled by a G-RNTI. The common DCI may be considered to be DCI scrambled by a G-RNTI. Alternatively, the DCI may be scrambled by a G-CS-RNTI. The G-CS-RNTI may be a RNTI used for an operation for Semi-persistent scheduling (SPS) in the MBS.

The common DCI may include DCI for multicast. A DCI format for multicast may be referred to as a DCI format 4_1 or DCI format 4_2. The DCI format 4_1 may be considered to be a DCI format corresponding to an existing DCI format 1_0. The DCI format 4_2 may be considered to be a DCI format corresponding to an existing DCI format 1_1. Formats are not limited to the DCI format 4_1 and DCI format 4_2, and any DCI format for multicast can be used.

Second, a functional block configuration of the gNB 100 will be described.

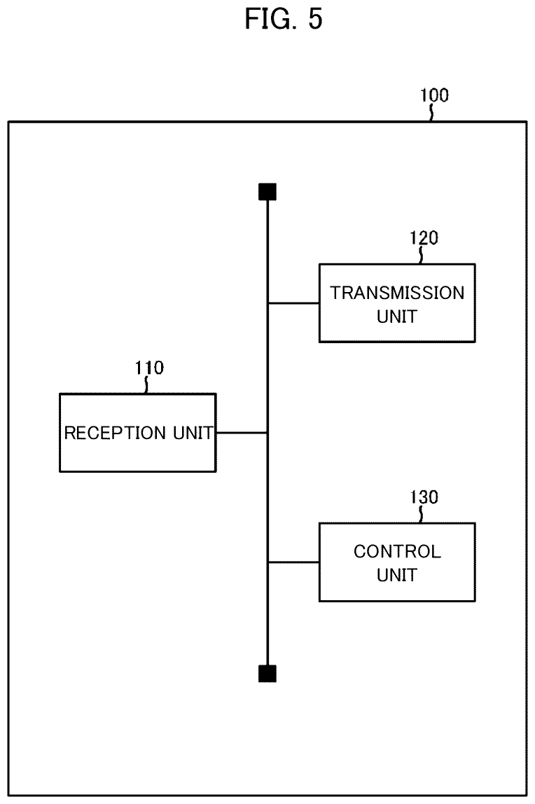

FIG. 5 is a functional block diagram of the gNB 100. As shown in FIG. 5, the gNB 100 includes a reception unit 110, a transmission unit 120, and a control unit 130.

The reception unit 110 receives various signals from the UE 200. The reception unit 110 may receive a UL signal via a PUCCH or PUSCH. In the embodiment, the reception unit 110 constitutes a reception unit that receives an information element (UE Capability) on whether a function for supporting a specific field which may be included in the common DCI is supported.

The transmission unit 120 transmits various signals to the UE 200. The transmission unit 120 may transmit a DL signal via a PDCCH or PDSCH. In the embodiment, the transmission unit 120 constitutes a transmission unit that transmits data via the PDSCH scheduled using the common DCI common to the plurality of UEs 200 in the MBS.

The control unit 130 controls the gNB 100. In the embodiment, the control unit 130 may assume that the UE 200, depending on whether to support a specific function for receiving at least one of MCCH and MTCH, performs a specific operation as an operation for receiving a selected logical channel.

### (3) Provision of MBS

Multicast and Broadcast Services (MBS) may be provided in the radio communication system 10.

In a stadium or hall, a large number of UEs 200 may be located in a certain geographic area and a large number of UEs 200 may simultaneously receive the same data, for example. In such a case, the use of the MBS instead of unicast is effective.

One specific UE 200 is specified (UE 200 specific identification information may be specified), and unicast may be interpreted as communication performed between the specific UE 200 and the network in a one-to-one relationship.

A plurality of specific UEs 200 are specified (multicast identification information may be specified), and multicast may be interpreted as communication performed between the network and the specific UEs 200 in a one-to-many relationship (special majority). The number of UEs 200 that receive data of the reception multicast may be one.

Broadcast may be interpreted as a communication performed between the network and all UEs 200 in a one-to-many relationship (unspecified majority). Multicast/broadcast data may have the same copied content, but some content, such as headers, may be different. Further, multicast/broadcast data may be transmitted (delivered) simultaneously, but it is not required that the data is necessarily transmitted (delivered) at exactly the same time. Propagation delays and/or processing delays within RAN nodes may be included.

A state of a radio resource control layer (RRC) of a target UE 200 may be any one of an idle state (RRC idle), a connected state (RRC connected), and another state (for example, inactive state). The inactive state may be interpreted as a state in which some configurations of the RRC are maintained.

In the MBS, the following three methods are assumed for scheduling of a multicast/broadcast PDSCH, specifically scheduling of a MBS packet (may be read as data). An RRC connected UE may be read as an RRC idle UE or RRC inactive UE.

### PTM Transmission Method 1 (PTM-1):

A group-common PDSCH is scheduled using a group-common Physical Downlink Control Channel (PDCCH) for a MBS group of the RRC connected UE.
CRC of a PDCCH and a PDSCH are scrambled by a group-common Radio Network Temporary Identifier (RNTI) (may be referred to as G-RNTI).

### PTM Transmission Method 2 (PTM-2):

A group-common PDSCH is scheduled using a terminal-specific (UE-specific) PDCCH for a MBS group of the RRC connected UE.
CRC of a PDCCH is scrambled by a UE-specific RNTI.
A PDSCH is scrambled by a group-common RNTI.

### PTP Transmission Method:

A UE-specific PDSCH is scheduled using a UE-specific PDCCH for the RRC connected UE.
CRC of a PDCCH and a PDSCH are scrambled by the UE-specific RNTI. This may mean that a MBS packet is transmitted by unicast.

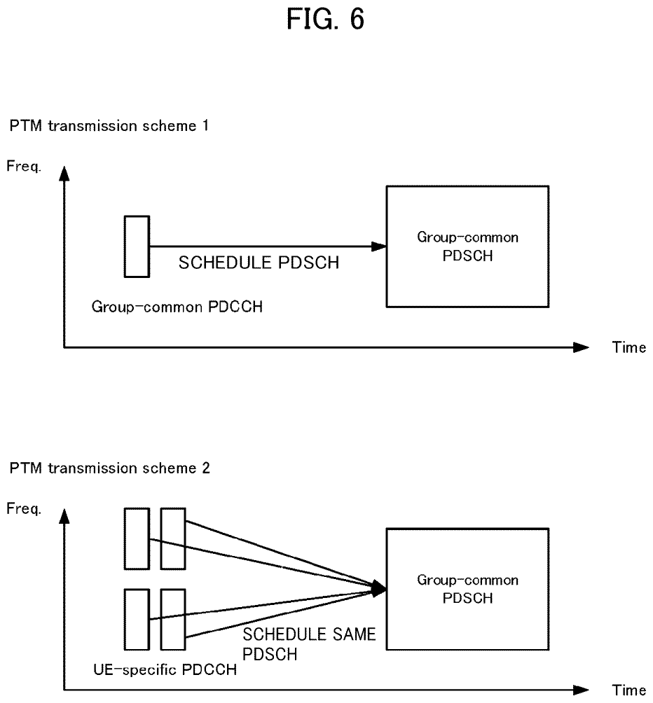

FIG. 6 shows configuration examples of the PTM transmission method 1 and PTM transmission method 2. The UE-specific PDCCH/PDSCH can be identified by a target UE, but may not be identified by other UEs in the same MBS group. The group-common PDCCH/PDSCH is transmitted at the same time/frequency resource and can be identified by all UEs in the same MBS group. The names of the PTM transmission method 1 and PTM transmission method 2 are tentative and different names may be used as long as the operations described above are performed.

In point-to-point (PTP) delivery, a RAN node may wirelessly deliver individual copies of MBS data packets to individual UEs. In point-to-multipoint (PTM) delivery, a RAN node may wirelessly deliver a single copy of MBS data packets to a set of UEs.

Further, in order to enhance the reliability of the MBS, the following two feedback methods are assumed for a Hybrid Automatic repeat request (HARQ) feedback, specifically, a HARQ feedback for a multicast/broadcast PDSCH.

Option 1: Both an ACK and NACK are Fed Back (ACK/NACK feedback).
A UE that successfully receives/decodes a PDSCH transmits an ACK.
A UE that fails to receive/decode a PDSCH transmits a NACK.
Physical Uplink Control Channel (PUCCH) resource configuration: PUCCH-Config can be configured for multicast.
A PUCCH resource: Shared/orthogonal between UEs depends on a network configuration.
HARQ-ACK codebook (CB): Type-1 and type-2 (CB decision algorithm (specified in 3GPP TS38.213)) is supported.
Multiplexing: Unicast or multicast can be applied.
   Option 2: Only a NACK is Fed Back (NACK-only feedback).
A UE that successfully receives/decodes a PDSCH does not transmit an ACK (does not transmit a response).
A UE that fails to receive/decode a PDSCH transmits a NACK.
In a prescribed UE, a PUCCH resource can be configured separately by unicast or group cast (multicast).

The ACK may be referred to as a positive acknowledgement and the NACK may be referred to as a negative acknowledgement. The HARQ may be referred to as an automatic repeat request.

For activation and deactivation (enable/disable) of Option 1 or Option 2, any of the following may be applied.
An RRC and Downlink Control Information (DCI)
An RRC only

Further, the following contents are assumed for Semi-persistent Scheduling (SPS) of a multicast/broadcast PDSCH.
An SPS group-common PDSCH is adopted.
A plurality of SPS group-common PDSCHs can be configured for UE Capability.
An HARQ feedback for an SPS group-common PDSCH is possible.
At least activation/deactivation by a group-common PDCCH (downlink control channel) is possible.

The deactivation may be read as another synonymous term such as release. The activation may be read as launch, start, trigger, and the like, and the deactivation may be further read as end, stop, and the like, for example.

An SPS is a scheduling used as a comparison with a dynamic scheduling, may be referred to as semi-fixed, semi-permanent, or semi-persistent scheduling, and may be interpreted as a Configured Scheduling (CS).

The scheduling may be interpreted as a process of assigning resources for transmitting data. The dynamic scheduling may be interpreted as a mechanism by which all PDSCHs are scheduled by DCI (for example, DCI 1_0, DCI 1_1, or DCI 1_2). The SPS may be interpreted as a mechanism by which PDSCH transmissions are scheduled by higher layer signaling, such as an RRC message.

Further, for a physical layer, there may be scheduling categories of a time-domain scheduling and frequency-domain scheduling.

Further, multicast, group cast, broadcast, and MBS may be read interchangeably. A multicast PDSCH and a PDSCH scrambled by a group common RNTI may be read interchangeably.

Further, terms such as data and packets may be read interchangeably, and may be interpreted as synonymous with terms such as signals and data units. Further, transmission, reception, transfer, and delivery may be read interchangeably.

### (4) Issue

In the embodiment, attention will be paid to the PTM-1 described above. An information element (UE Capability) on whether to support a specific function for receiving the MCCH and MTCH is defined. The UE 200 may transmit an information element (UE Capability) on whether to support a specific function to the network.

Under this kind of background, a case can be assumed in which a UE supporting a specific function for receiving the MCCH/MTCH and a UE not supporting a function for receiving the MCCH/MTCH are mixed.

In such a case, for UE 200 in the connected state, an information element (UE Capability) on whether the UE 200 supports a specific function is reported to the network. Therefore, the network can take action not to use the specific function for the UE 200 which does not support the specific function.

Meanwhile, the UE Capability described above of the UE 200 in the idle or inactive state is not reported to the network. Therefore, the network may not apprehend the UE 200 which does not support a specific function and may transmit the MCCH/MTCH which requires a specific function.

In view of such a situation, the inventors have found the necessity to clarify an operation of a UE which does not support a function for receiving the MCCH/MTCH.

### (5) Operation Examples

In order to solve the problem described above, operation examples according to the embodiment will be described. In the operation examples, a specific function for receiving a logical traffic channel (MTCH) will be mainly described. The specific function may be one or more functions selected from dynamic repetition indication, RB-level rate-matching, and RE-level rate-matching.

In this kind of case, the UE 200 performs a specific operation as an operation for receiving a logical traffic channel depending on whether to support a specific function. The following options can be considered as the specific operation.

### (5.1) Option 1

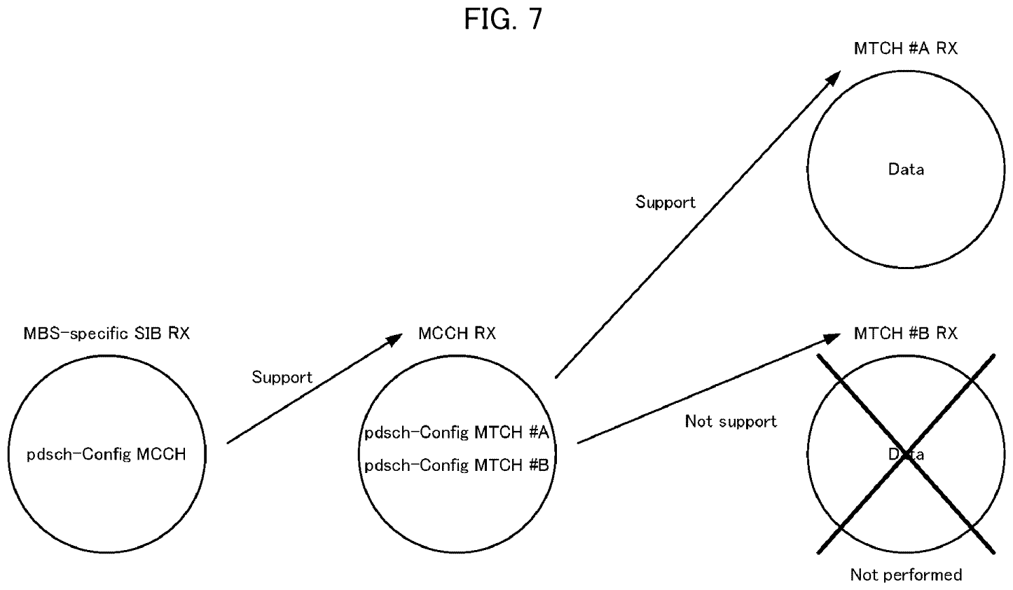

In Option 1, the following specific operations may be performed. Option 1 will be described with reference to FIG. 7.

First, the UE 200 receives broadcast information for the MBS (for example, MBS-specific SIB). The MBS-specific SIB includes a configuration for receiving the MCCH (pdcch-Config-MCCH/pdsch-Config-MCCH). The MCCH is a higher-layer channel in which control information for receiving data on the MBS is transmitted.

Second, the UE 200 receives the logical control channel (MCCH) based on the configuration for receiving the MCCH. The MCCH includes the configuration for receiving the MTCH (pdcch-Config-MTCH/pdsch-Config-MTCH). The MTCH is a higher-layer channel in which data on the MBS is transmitted.

Third, the UE 200 performs a specific operation as an operation for receiving the logical traffic channel (MTCH), based on the configuration for receiving the MTCH. Specifically, the UE 200 does not receive an MTCH which uses a specific function not supported by the UE 200 when the configuration for receiving the MTCH includes the specific function not supported by the UE 200. Meanwhile, the UE 200 receives an MTCH which uses a specific function supported by the UE 200 when the configuration for receiving the MTCH includes the specific function supported by the UE 200. The UE 200 may receive an MTCH which uses only a specific function supported by the UE 200 without using a specific function not supported by the UE 200.

As shown in FIG. 7, if the MCCH includes two MTCH configuration sets (MTCH #A and MTCH #B), the UE 200 may receive the MTCH #A which uses a specific function not supported by the UE 200 without receiving the MTCH #B which uses a specific function not supported by the UE 200, for example.

According to Option 1, an operation for receiving an MTCH which uses a specific function not supported by the UE 200 is clarified, and the execution of a useless MTCH receiving operation can be suppressed.

### (5.2) Option 2

In Option 2, if a specific function not supported by the UE 200 is configured, by assuming that a parameter related to the specific function is a specific parameter, the UE 200 may receive the logical traffic channel (MTCH).

A case where the specific function is a dynamic repetition indication will be described, for example. In this kind of case, when a dynamic repetition indication not supported by the UE 200 is configured, by assuming that a parameter related to the number of repetitions of the MTCH is a specific parameter (for example, the number of repetitions =“1”), the UE 200 may receive an MTCH using the dynamic repetition indication

According to Option 2, even if the UE 200 does not support a specific function, the UE 200 can receive an MTCH using the specific function.

### (5.3) Option 3

In Option 3, when a specific function not supported by the UE 200 is configured, and if a parameter related to the specific function is not required, the UE 200 may receive the logical traffic channel (MTCH).

A case where a specific function is RE-level rate-matching for a ZP-CSI-RS will be described, for example. In this kind of case, when the RE-level rate-matching for a ZP-CSI-RS not supported by the UE 200 is configured, and if resources assigned to an MTCH do not include the ZP-CSI-RS, the UE 200 may determine that the RE-level rate-matching is not required and receive an MTCH that uses the RE-level rate-matching.

According to Option 3, even if the UE 200 does not support a specific function, by allowing the UE 200 to receive an MTCH which uses a specific function as much as possible, it is possible to enhance utilization efficiency of resources.

### (5.4) Option 4

In Option 4, when a specific function not supported by the UE 200 is configured, the UE 200 performs a connection procedure for the network (for example, RRC connection establishment) and also performs an operation for transmitting an information element (UE Capability) on whether to support a specific function to the network. The connection procedure may include a Random Access (RA) procedure with PRACH transmission.

According to Option 4, the UE 200 reports an information element (UE Capability) on whether to support a specific function by transitioning to the connected state. This enables the network to apprehend the UE Capability and to transmit an MTCH using a specific function supported by the UE 200. In other words, by transitioning to the connected state and reporting the UE Capability, the UE 200 may receive an MTCH using a specific function supported by the UE 200.

Option 4 may be combined with at least one of Options 1 to 3 described above.

### (5.5) Option 5

In Option 5, the UE 200 performs a specific operation as an operation for receiving a logical traffic channel (MTCH) until a change notification for a logical control channel (MCCH) is received. The change notification for an MCCH may be referred to as an MCCH change notification. The MCCH change notification may be included in DCI format 4_0. The MCCH change notification is composed of two bits and may include bits for updating configurations of sessions being applied and bits for notifying the start of new sessions.

The UE 200 performs an operation for receiving an MTCH using the MTCH configuration set during a time period between the reception of the MTCH configuration set and the reception of a change notification by the MCCH change notification, for example. An operation for receiving an MTCH using a specific function not supported by the UE 200 may be any one of Options 1 to 4 described above. An operation for receiving an MTCH using a specific function supported by the UE 200 may be a usual operation for receiving an MTCH.

According to this kind of configuration, in response to the reception of the change notification by the MCCH change notification, the UE 200 can quickly apprehend the transmission of an MTCH using a specific function supported by the UE 200, and can quickly start receiving the MTCH using the specific function supported by the UE 200.

### (6) Action and Effect

In the embodiment, the UE 200 performs a specific operation as an operation for receiving a logical channel (MCCH/MTCH) depending on whether to support a specific function. That is, an operation for receiving a logical channel (MCCH/MTCH) using a specific function supported by the UE 200 and an operation for receiving a logical channel (MCCH/MTCH) using a specific function not supported by the UE 200 are defined. According to this kind of configuration, the UE 200 can appropriately receive the MCCH/MTCH even if a case is assumed in which a UE supporting a specific function for receiving the MCCH/MTCH and a UE not supporting a function for receiving the MCCH/MTCH are mixed.

### (7) Other Embodiments

Although the contents of the present invention have been described in accordance with the embodiment, the present invention is not limited to the descriptions, and it is obvious to those skilled in the art that various modifications and improvements are possible.

In the above disclosure, the specific function for receiving the logical traffic channel (MTCH) has been mainly described. However, the above disclosure is not limited thereto. The specific function may be a function for receiving the logical control channel (MCCH).

In the above disclosure, the dynamic repetition indication, RB-level rate-matching, and RE-level rate-matching have been exemplified as specific functions. However, the above disclosure is not limited thereto. The specific functions may be other functions for receiving the MTCH and MCCH.

In the above disclosure, Options 1 to 5 have been described individually. However, the above disclosure is not limited thereto. Options 1 to 5 may be combined.

Although not specifically described in the above disclosure, Options 1 to 5 may be applied to the UE 200 in the idle or inactive state.

Although not specifically described in the above disclosure, the following UE Capability may be defined. UE Capability may include an information element indicating whether a function for supporting the MBS is provided. The UE Capability may include an information element indicating whether a function for supporting DCI format 4_1 used in the MBS is provided. The UE Capability may include an information element indicating whether a function for supporting DCI format 4_2 used in the MBS is provided. The UE Capability may include an information element indicating whether a function for supporting PTM-1 is provided. The UE Capability may include an information element indicating whether a function for supporting PTM-2 is provided. The UE Capability may include an information element indicating whether a function for supporting the common DCI is provided, and in the common DCI, CRC is scrambled by the G-RNTI.

The above disclosure may be applied to the UE 200 which has reported that the UE has a function for supporting the MBS as the UE Capability. The above disclosure may be applied to the UE 200 which has reported that the UE has a function for supporting the DCI format 4_1 or DCI format 4_2 used in the MBS as the UE Capability. The above disclosure may be applied to the UE 200 which has reported that the UE has a function for supporting the PTM-1 as the UE Capability. The above disclosure may be applied to the UE 200 which has reported that the UE has a function for supporting the common DCI as the UE Capability, and in the common DCI, CRC is scrambled by the G-RNTI. The above disclosure may be applied to the UE 200 in which an operation for the MBS is configured.

In addition, although the MBS PDSCH has been described as an example in the above disclosure, at least any of the above-described operation examples may be applied also in other downlink channels such as the MBS PDCCH. Furthermore, the above-described operation examples may be combined and compositely applied as long as there is no contradiction.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIGS. 4 and 5) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

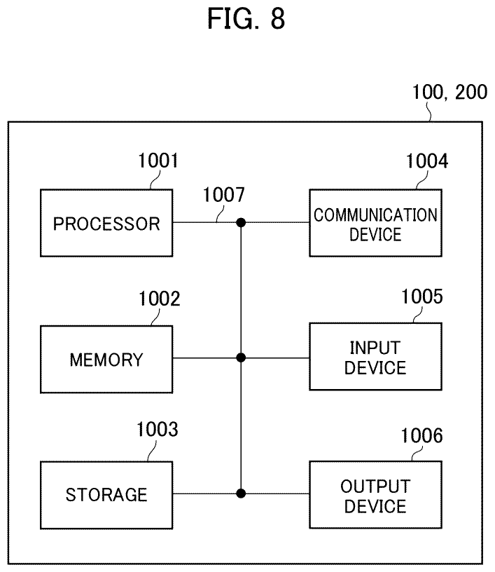

Further, the above-described gNB 100 and UE 200 (the device) may function as a computer that performs processing of a radio communication method of the present disclosure. FIG. 8 is a diagram illustrating an example of a hardware configuration of the device. As illustrated in FIG. 8, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIG. 4) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a base station. In this case, the base station may have the function of the mobile station.

A radio frame may be composed of one or more frames in the time domain. Each of the one or more frames in the time domain may be referred to as a subframe.

A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a subcarrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

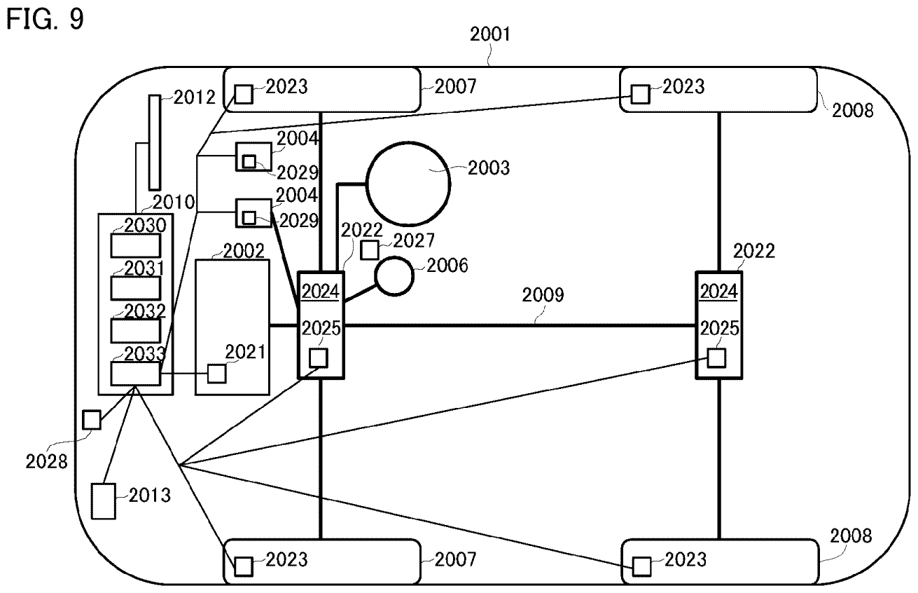

FIG. 9 shows a configuration example of a vehicle 2001. As shown in FIG. 9, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor.

The steering 2003 includes at least a steering wheel (also called a handle) and steers at least one of the front and rear wheels based on an operation of a steering wheel operated by a user.

The electronic controller 2010 includes a microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a light detection and ranging (LiDAR), a camera, a positioning locator (for example, GNSS), map information (for example, high-definition (HD) maps, autonomous vehicle (AV) maps, and the like), a gyroscopic system (for example, an inertial measurement unit (IMU), an inertial navigation system (INS), and the like), an artificial intelligence (AI) chip, and an AI processor for providing functions to prevent accidents or reduce a driving load of a driver, and one or more ECUs for controlling these devices. Further, the driver support system unit 2030 transmits and receives various kinds of information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a base station, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like. provided in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
110 Reception unit
120 Transmission unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus
2001 Vehicle
2002 Drive unit
2003 Steering unit
2004 Axel pedal
2005 Brake pedal
2006 Shift lever
2007 Left and right front wheels
2008 Left and right rear wheels
2009 Axles
2010 Electronic control unit
2012 Information service unit
2013 Communication module
2021 Current sensor
2022 Rotational speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system unit
2031 Microprocessor
2032 Memory (ROM, RAM)
2033 Communication port

1. A terminal comprising:
a reception unit that receives data via a downlink channel scheduled using common downlink control information common to a plurality of terminals in a data delivery to the plurality of terminals; and
a control unit that performs a specific operation as an operation for receiving at least one logical channel from among a logical control channel and a logical traffic channel related to the data delivery to the plurality of terminals, depending on whether to support a specific function for receiving the at least one logical channel.

2. The terminal according to claim 1, wherein
the control unit performs, as the specific operation, an operation for receiving the at least one logical channel using the specific function supported by the terminal without receiving the at least one logical channel using the specific function not supported by the terminal.

3. The terminal according to claim 1, wherein
when the specific function not supported by the terminal is configured, by assuming that a parameter related to the specific function is a specific parameter, the control unit receives the at least one logical channel as the specific operation.

4. The terminal according to claim 1, wherein
when the specific function not supported by the terminal is configured, and when a parameter related to the specific function is not required, the control unit receives the at least one logical channel as the specific operation.

5. The terminal according to claim 1, wherein
when the specific function not supported by the terminal is configured, the control unit performs a connection procedure for a network and also performs an operation for transmitting an information element on whether to support the specific function to the network as the specific operation.

6. The terminal according to claim 1, wherein
the control unit performs the specific operation as an operation for receiving the logical traffic channel until a change notification for the logical control channel is received.

7. A radio communication method comprising:
a step of receiving data via a downlink channel scheduled using common downlink control information common to a plurality of terminals in a data delivery to the plurality of terminals; and
a step of performing a specific operation as an operation for receiving at least one logical channel from among a logical control channel and a logical traffic channel related to the data delivery to the plurality of terminals, depending on whether to support a specific function for receiving the at least one logical channel.

8. The terminal according to claim 2, wherein
when the specific function not supported by the terminal is configured, the control unit performs a connection procedure for a network and also performs an operation for transmitting an information element on whether to support the specific function to the network as the specific operation.

9. The terminal according to claim 3, wherein
when the specific function not supported by the terminal is configured, the control unit performs a connection procedure for a network and also performs an operation for transmitting an information element on whether to support the specific function to the network as the specific operation.

10. The terminal according to claim 4, wherein
when the specific function not supported by the terminal is configured, the control unit performs a connection procedure for a network and also performs an operation for transmitting an information clement on whether to support the specific function to the network as the specific operation.
